(19) United States
(12) Patent Application Publication
(10) Pub. No.: US 2023/0146737 A1
(43) Pub. Date: May 11, 2023

(54) Methods for Selecting, Inspecting and Evaluating Brackets and Their Fastening Configurations in Construction

(71) Applicant: Simpson Strong-Tie Company A/S, Odder (DK)

(72) Inventor: Jacob Hansen, Odder (DK)

(21) Appl. No.: 17/910,777

(22) PCT Filed: Mar. 9, 2021
(86) PCT No.: PCT/EP2021/055917

§ 371 Date: Sep. 9, 2022

(30) Foreign Application Priority Data
Mar. 9, 2020 (DK) PA 2020 00310

(51) Int. Cl. G06V 20/20; G06T 7/00; E04B 1/41

(52) U.S. Cl. CPC G06V 20/20; E04B 1/40; G06T 7/0004; E04B 2001/405

(57) ABSTRACT

A computer-implemented method for deciding on a bracket connection is provided. The method comprises selecting one of a specific bracket type or a specific configuration of a supported member and a supporting member, identifying, based on the selected bracket type if such is selected, at least one configuration of a supported member and a supporting member associated with the selected bracket type, or, based on the selected specific configuration of a supported member and a supporting member if such is selected, at least one bracket type being associated with the configuration of the supported member and the supporting member, the bracket and the configuration of the supported member and the supporting member together forming a bracket connection, and determining one or more properties of the identified bracket connection.

### TECHNICAL FIELD

The present invention relates to brackets used in construction, and especially to methods for selecting, inspecting, and evaluating brackets and their fastening configurations in building construction.

### BACKGROUND

Construction work requires a vast amount of brackets. A bracket is typically used as an intermediate component for fixing one constructional component to another constructional component. Such assembly of two structural elements, such as beams etc., is normally performed so as to arrange the constructional elements at an angle of 90° relative to each other. Hence, a common bracket is a metal L-shape whereby one side (or flange) of the metal bracket is screwed to the first structural component, and the other side (or flange) of the metal bracket is screwed to the second structural component.

There exist a number of different brackets on the market. For example, the present applicant is producing and offering a wide variety of bracket connectors ranging from simple angles, framing anchors, reinforced angle brackets, curtain wall connectors, adjustable angle brackets, nail plate angle brackets, etc. Even further, these brackets are provided in various sizes and gauges to fit with different dimensions and materials of the associated structural elements. To further extend the versatility of the brackets, they are provided with a configuration of fastening holes that can be used differently depending on the requirements of the particular connection.

For a specific building project, there is thus an incredible large number of different combinations of structural components, i.e. the supporting member and the supported member, bracket types, bracket sizes, and bracket fastening combinations.

Even if the project management for the constructional work to be carried out is careful in deciding which bracket(s) is/are to be used at each connection, there is still a great responsibility on the construction worker to not only select the proper bracket for each bracket connection, but also to select the proper use of the fastening configuration for the bracket.

As there is a significant risk that a wrong type of bracket is used, or a wrong type of fastening configuration is used, there is need for improvements in deciding which brackets to use, and in which configuration. This also goes for inspecting and evaluating existing bracket connections, as the load capability of a bracket may be significantly reduced if it is attached in a non-optimal manner.

The present invention seeks to eliminate, alleviate, mitigate or reduce at least some of the problems referred to above, by providing improved methods for selecting, inspecting, and evaluating brackets and their fastening configurations in building construction environments.

According to a first aspect of the present invention, a computer-implemented method is provided. The method is implemented on a mobile terminal (or device) for deciding on a bracket connection, and comprises i) selecting a specific bracket type, ii) identifying, based on the selected bracket type, at least one configuration of a supported member and a supporting member associated with the selected bracket type, the bracket and the configuration of the supported member and the supporting member together forming a bracket connection, and iii) determining one or more properties of the identified bracket connection.

The step of selecting a specific bracket type may be performed by a user scanning a bracket bar code (or QR code or other such coding), by a user inputting a specific bracket ID, such as a bracket article number, and/or by a user recording image data of an existing bracket, and determining the specific bracket type from said image data.

According to a second aspect of the present invention, a computer-implemented method is provided. The method is implemented on a mobile terminal (or device) for deciding on a bracket connection, and comprises i) selecting a specific configuration of a supported member and a supporting member, ii) identifying, based on the selected configuration of a supported member and a supporting member, at least one bracket type being associated with the configuration of the supported member and the supporting member, the bracket and the configuration of the supported member and the supporting member together forming a bracket connection, and iii) determining one or more properties of the identified bracket connection.

The first and second aspects of the present invention may be combined, in which a computer-implemented method is provided. The method is implemented on a mobile terminal (or device) for deciding on a bracket connection, and comprises i) selecting one of a specific bracket type or a specific configuration of a supported member and a supporting member, ii) identifying, based on the selected bracket type if such is selected, at least one configuration of a supported member and a supporting member associated with the selected bracket type, or, based on the selected specific configuration of a supported member and a supporting member if such is selected, at least one bracket type being associated with the configuration of the supported member and the supporting member, the bracket and the configuration of the supported member and the supporting member together forming a bracket connection, and iii) determining one or more properties of the identified bracket connection.

The step of selecting a specific configuration of the supported member and the supporting member may be performed by a user recording image data of an existing configuration, and determining the specific configuration from said image data.

For each of the aspects mentioned above some preferred embodiments will be described below by way of example only.

The methods may comprise presenting said bracket connection properties to a user.

The bracket connection properties may comprise a maximum load capability of the bracket connection.

The bracket connection properties may comprise a fastening configuration, i.e. the specific number of fasteners to use, and/or in which pattern fasteners are to be used or attached.

The methods may further comprise presenting the determined bracket connection to a user.

Presenting the determined bracket connection may be performed using augmented reality, adding a graphical model of the identified bracket type to the image of the support members configuration, or adding a graphical model of the support members configuration to the image of the bracket type.

The method may further comprise inspecting and evaluating a bracket connection by recording an image of an existing bracket connection, determining the bracket type and support member configuration from said recorded image, the bracket type and support member configuration together forming a determined bracket connection, and determining a possible load capability of the determined bracket connection based on the existing and determined bracket connection.

According to a third aspect of the present invention, a computer-implemented method is provided. The method is implemented on a mobile terminal (or device)for inspecting and evaluating a bracket connection, and comprises i) recording an image of an existing bracket connection, ii) determining the bracket type and support member configuration from said recorded image, the bracket type and support member configuration together forming a determined bracket connection, and iii) determining a possible load capability of the determined bracket connection based on the determined bracket connection.

The method may further comprise presenting information regarding the determined load capability to a user.

The method may further comprise comparing the determined possible load capability with a maximum load capability of the bracket connection, and presenting information relating to said comparison to the user.

The step of determining the possible load capability of the bracket connection may further be based on additional bracket connection properties.

Additional bracket connection properties may comprise the used fastening hole configuration, the type of fasteners used, type of material of the supported member and/or the supporting member, such as orientation of wood fibres in case any of the supporting or supported members are made of wood, type of wood/concrete in case any of the supporting or supported members are made of concrete, actual density of the particular material, moisture content of the supporting or supported members, and/or age of the bracket.

The step of determining the possible load capability of the bracket connection may be further based on additional building site properties, such as location and/or air composition.

According to a fourth aspect, a data processing apparatus, such as a mobile terminal (or device), is provided. The data processing apparatus comprises a processor adapted to perform the method according to any of the aspects described above.

According to a fifth aspect of the present invention, a computer program is provided. The computer program comprises instructions which, when the program is executed by a computer or processor, cause the computer or processor to carry out the method according to any of the aspects described above.

According to a sixth aspect of the present invention, a computer-readable medium is provided. The computer-readable medium comprises instructions which, when executed by a computer or processor, cause the computer or processor to carry out the method according to any of the first, second, or third aspect described above.

Other aspects of the present invention and its embodiments are defined by the appended claims and are further explained by way of example only in the detailed description section as well as being illustrated in the drawings.

Within the context of this application the term “bracket” should be interpreted broadly to cover all connecting hardware which is intended to connect one structural member to another structural member. Such hardware components, all to fall within the “bracket” definition of this application, can be referred to by various terms such as “connectors”, “ties”, “angles”, etc. when used in building constructions.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The present invention will now be described, by way of example only, with reference to the accompanying drawings, in which:

FIG. 1 is a schematic illustration of a non-limiting example of a communication system in which embodiments of the present invention may be exercised;

FIG. 2 is a schematic front view of a mobile communication terminal (or device) according to one embodiment, in the form of a smartphone having a touch display;

FIG. 3 is a schematic block diagram illustrating the basic internal hardware and software layout of a mobile communication terminal according to one embodiment;

FIG. 4 is an isometric view of a bracket connection;

FIGS. 5a-b are schematic views of methods according to various embodiments;

FIG. 6a is a schematic view of a mobile terminal (or device) running a mobile application executing a method according to an embodiment;

FIG. 6b is a schematic view of a step of a method according to an embodiment;

FIG. 7 is a schematic view of another method according to an embodiment;

FIG. 8 is a schematic view of a step of a method according to an embodiment; and

FIGS. 9a-r are screenshots of a mobile application executing different methods according to various embodiments.

### DETAILED DESCRIPTION

Preferred embodiments of the present invention will now be described by way of example only with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

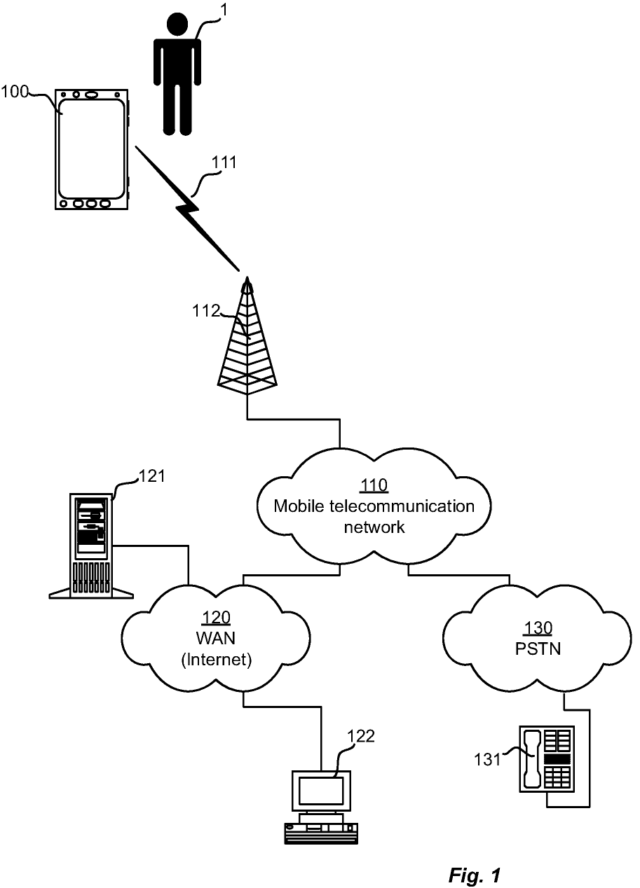

Before turning to a detailed description of the disclosed embodiments of the methods according to the invention, an exemplifying environment in which such embodiments may be exercised will now be briefly described with reference to FIGS. 1-3. Especially, since the computer-implemented methods according to the invention are preferably executed on a mobile communications terminal (or device), as a mobile application, a telecommunication system will be described as the communication system, as one example only.

In FIG. 1, a portable electronic device in the form of a mobile communication terminal 100 is part of a cellular telecommunications system. A user 1 of the mobile communication terminal 100 may use different telecommunications services, such as voice calls, Internet browsing, still image transmissions, video transmissions, electronic messaging, etc. Especially, for the methods described herein data transmission would be the required service.

The mobile communication terminal 100 may connect to a mobile telecommunication network 110 over a radio link 111 and a base station 112. The mobile communication terminal 100 and the mobile telecommunication network 110 may comply with any commercially available mobile telecommunication standard, for instance (without limitation) GSM, UMTS, LTE, D-AMPS, CDMA2000, FOMA and TD-SCDMA. Embodiments of the mobile communication terminal 100 will be described in more detail with reference to the following drawings.

A public switched telephone network (PSTN) 130 is connected to the mobile telecommunication network 110. Telephone terminals of PSTN subscribers may connect to the PSTN 130. In FIG. 1, a stationary telephone 131 is indicated as a mere example of this.

The mobile telecommunication network 110 is operatively associated with a wide area data network 120, which may be the Internet or a part thereof. Server computers 121 and client computers 122 may be connected to the wide area data network 120 to allow communication with the mobile terminal 100.

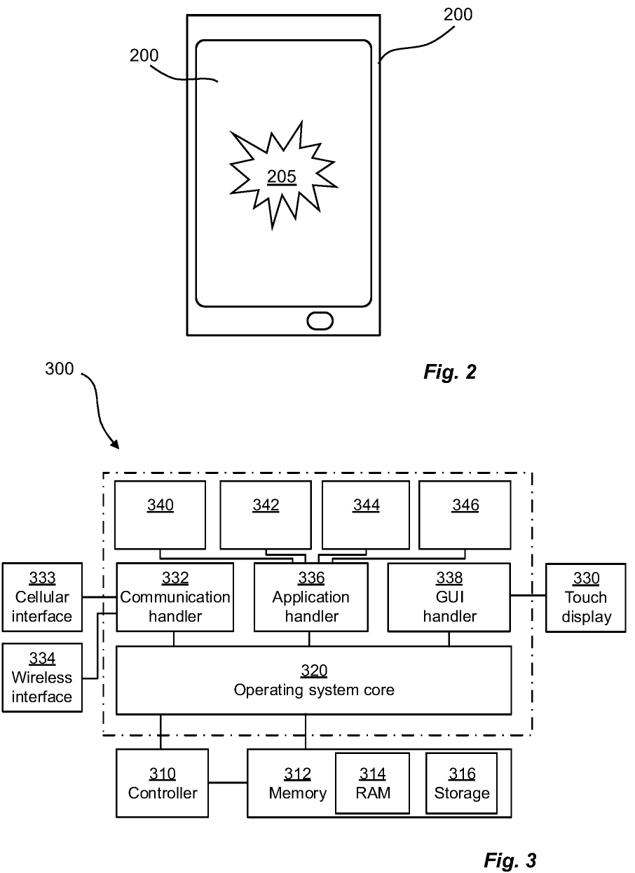

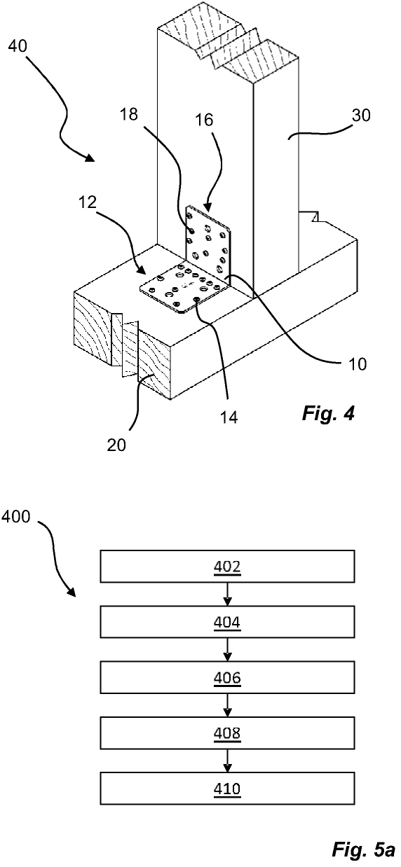

An embodiment 200 of the mobile communication terminal 100 is illustrated in more detail in FIG. 2. The mobile communication terminal 200 is of smartphone-type and has a touch-sensitive display screen 202, or simply a touch display. The touch display 202 provides a graphical user interface GUI, 205, to a user of the mobile communication terminal 200. The GUI 205 will allow the user 1 to interact with the mobile application executing the methods that will be explained below with reference to FIG. 4 and onwards.

The internal software and hardware structure of a mobile communication terminal 300, for instance the mobile communication terminal 200 according to the embodiment shown in FIG. 2, will now be described with reference to FIG. 3. Software components are indicated within a dash-dotted frame, whereas hardware components are outside of this frame. The mobile communication terminal has a controller 310 being responsible for general device operations. Any commercially available central processing unit (CPU) or digital signal processor (DSP), or other programmable electronic logic device such as an application-specific integrated circuit (ASIC) or field-programmable gate array (FPGA), may be used to implement the controller 310. The controller 310 has associated memory 312 which includes a work memory (RAM) 314 and a non-volatile storage memory 316, for instance in the form of EEPROM, flash memory (e.g. memory card), hard disk, or any combination thereof. The controller 310 uses the memory 312 for different purposes, for instance for storing file objects as well as data and program instructions for the software in the mobile communication terminal.

The software includes an operating system core 320 on a lower level, application programs 340-346 on an upper level for interaction with the user (of which at least one is programmed to execute the methods of the present invention), and drivers and handlers for the hardware and the application programs on an intermediate level. The intermediate level includes a GUI handler 338 which forms a graphical user interface (such as GUI 205 in FIG. 2) towards the user (such as user 1 in FIG. 1) by controlling the touch display 330 (such as touch display 202 in FIG. 2).

An application handler 336 controls the application programs 340-346. The software also includes various modules, protocol stacks, drivers, etc., which are commonly designated as communication handler 332 and which provide communication support for a cellular interface 333 and, optionally, a wireless interface for Bluetooth, WLAN, NFC and/or IrDA (commonly designated as 334 in FIG. 4). The cellular interface 333 comprises an internal or external antenna as well as appropriate radio circuitry for establishing and maintaining a wireless link to a base station (e.g. the link 111 and base station 112 in FIG. 1). The radio circuitry comprises a radio transmitter and receiver (transceiver; TX/RX), formed for instance by band pass filters, amplifiers, mixers, local oscillators, low pass filters, AD/DA converters, etc.

Now turning to FIG. 4, an example of building construction environment is schematically shown. A bracket 10 is used to rigidly connect a supporting member 20 to a supported member 30, thereby forming a bracket connection 40. The bracket 10, which in this example is an L-shaped angle connector, comprises a first part 12 having a first set of fastening holes 14 and second part 16 having a second set of fastening holes 18. The first part 12 is connected to the supporting member 20 by screwing one or more screws through the fastening holes 14, while the second part 16 is connected to the supported member 30 by screwing one or more screws through the fastening holes 18.

The bracket 10 is preferably constructed from a sheet metal, such as stainless steel or similar, and is constructed to provide a robust attachment between the two members 20, 30. The set of fastening holes 14, 18 are distributed such that they can be used in different configurations depending on the specifications on the bracket 10 per se, as well as on the specifications on the supporting and supported members 20, 30.

Hence, when it is desired to use a specific bracket 10 for connecting a supporting member 20 to a supported member 30 it is important to consider at least the following parameters: bracket type, bracket dimensions, bracket material, material of the supporting member 20, and material of the supported member 30. Knowing these parameters, it is possible to determine a required load capability of the bracket connection 40, as well as the exact use of the fastening holes 14, 18 to cope with the required load capability.

Yet further, additional parameters may affect the load capability of the bracket connection 40. Such additional parameters may e.g. be material specifics, such as orientation of wood fibres in case any of the supporting or supported members 20, 30 are made of wood, type of wood/concrete (in case any of the supporting or supported members 20, 30 are made of concrete), actual density of the particular material (such as wood or concrete), types of fasteners, i.e. specific types of nails or screws, moisture content of the supporting or supported members 20, 30, as well as air composition at the actual building construction site.

When facing such complex relationship between load capability and the affecting factors for bracket connections 40 the inventors have surprisingly realized improved methods for not only assist in decision making, but also for allowing inspection and evaluation of existing bracket connections.

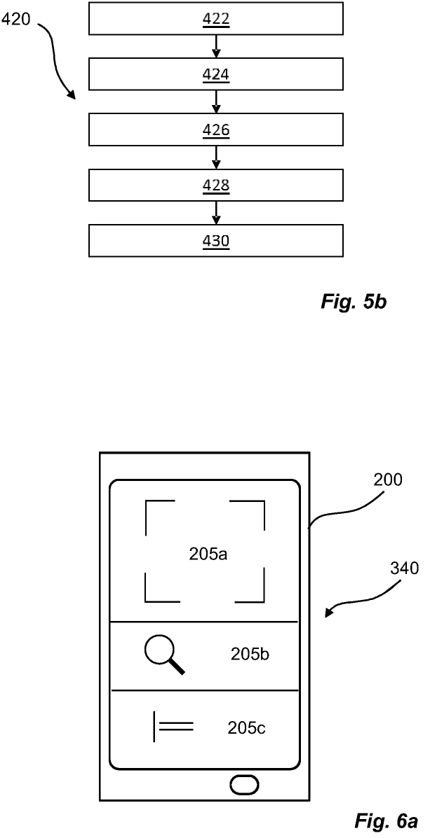

Starting in FIG. 5a, a computer-implemented method 400 for deciding on a particular bracket connection 40 is schematically shown. The method 400 is preferably performed by a user 1 accessing a dedicated mobile application 340- 346 on a mobile terminal 200, whereby the user 1 is allowed to provide user input to the mobile application 200, and hence to the method 400, through the GUI 205.

The method 400 comprises a first step 402 of selecting a specific bracket 10. This step may be performed by the user 1 being prompted to select a specific bracket 10 from a list of available brackets 10, or e.g. by the user 1 scanning a bracket code, such as a bar code, via the mobile application 340-346.

The method 400 further comprises a step 404 of determining one or more associated bracket connections 40 for the selected bracket 10, and optionally a step 406 of reducing the determined plurality of bracket connections 40 to only one bracket connection 40. Step 404 may e.g. be performed by the mobile application 340-346 accessing a database storing a list of intended bracket connections 40, i.e. type and configuration of intended supporting and supported members 20, 30 for the associated bracket 10. Hence, step 404 is performed based on the selected bracket 10 from step 402. Step 406 may be performed by displaying a plurality of available bracket connections 40 to the user through the GUI 205, and receiving user input to select a single bracket connection 40 from the plurality of bracket connections 40. Hence, the user 1 may choose the desired bracket connection 40 from a list of available bracket connections 40, after allowing the method 400 to previously narrow down the selection.

Once the desired bracket connection 40 is determined, using the selected bracket 10 as input, the method 400 performs a step 408 of determining an exact fastening configuration for the bracket connection 40. This step 408 results in a visual representation of which fastening holes 14, 18 to use, optionally together with a specific type of fastener. Once the fastening configuration is determined, the method 400 may also calculate, in step 410, the maximum load capability of the determined bracket connection 40.

In one embodiment step 408 provides alternative fastening configurations for the user to choose between. For example, the user may have the option to choose between a maximum load capability and a minimum load capability for the bracket connection 40. Each of the available fastening configurations provides a visual representation of which fastening holes 14, 18 to use, optionally together with a specific type of fastener, as well as the specific load capability for the determined bracket connection 40. Typically, a minimum load capability requires a less amount of fasteners than a maximum load capability, and/or a different pattern for the fasteners.

Another computer-implemented method 420 for deciding on a particular bracket connection 40 is schematically shown in FIG. 5b. The method 420 is preferably performed by a user 1 accessing a dedicated mobile application 340- 346 on a mobile terminal 200, whereby the user 1 is allowed to provide user input to the mobile application 200, and hence to the method 420, through the GUI 205.

The method 420 comprises a first step 422 of selecting a specific configuration of the members 20, 30 to be connected by means of a bracket 10. This step may be performed by the user 1 being prompted to select a specific support member configuration 20, 30 from a list of available configurations. In a more preferred embodiment, step 422 is performed using capabilities of the mobile terminal 200 as well as dedicated software for augmented reality. This means that the user 1 may, by starting the mobile application 340-346, access the camera of the mobile terminal 200 and film a real and existing configuration of the support members 20, 30. Step 422 is thereby performed by the method 420 automatically identifying and selecting the specific configuration of the members 20, 30.

The method 420 further comprises a step 424 of determining one or more associated brackets 10, and optionally a step 426 of reducing the determined plurality of brackets 10 to only one specific bracket 10 for the identified support member configuration. Step 424 may e.g. be performed by the mobile application 340-346 accessing a database storing a list of intended brackets 10, i.e. type and dimensions, an optionally also material, of the associated bracket 10 that is suitable for the identified and selected support members 20, 30. Hence, step 424 is performed based on the selected configuration of the support members 20, 30. Step 426 may be performed by displaying a plurality of available brackets 10 to the user through the GUI 205, and receiving user input to select a single bracket 10 from the plurality of brackets 10. Hence, the user 1 may choose the desired bracket 10 from a list of available brackets 10, after allowing the method 420 to previously narrow down the selection.

Steps 424, 426 may also be performed by immediately, once the user 1 is directing the camera at the existing support members 20, 30, suggesting a suitable bracket 10 that may form a bracket connection 40 together with the support members 20, 30.

Once the desired bracket 10 is determined, using the selected support member configuration as input, the method 420 performs a step 428 of determining an exact fastening configuration for the determined bracket connection 40. This step 428 results in a visual representation of which fastening holes 14, 18 to use, optionally together with a specific type of fastener. Once the fastening configuration is determined, the method 420 may also calculate, in step 430, the maximum load capability of the determined bracket connection 40.

As for the method 400 described above, in one embodiment step 428 provides alternative fastening configurations for the user to choose between. For example, the user may have the option to choose between a maximum load capability and a minimum load capability for the bracket connection 40. Each of the available fastening configurations provides a visual representation of which fastening holes 14, 18 to use, optionally together with a specific type of fastener, as well as the specific load capability for the determined bracket connection 40. Typically, a minimum load capability requires a less amount of fasteners than a maximum load capability, and/or a different pattern for the fasteners.

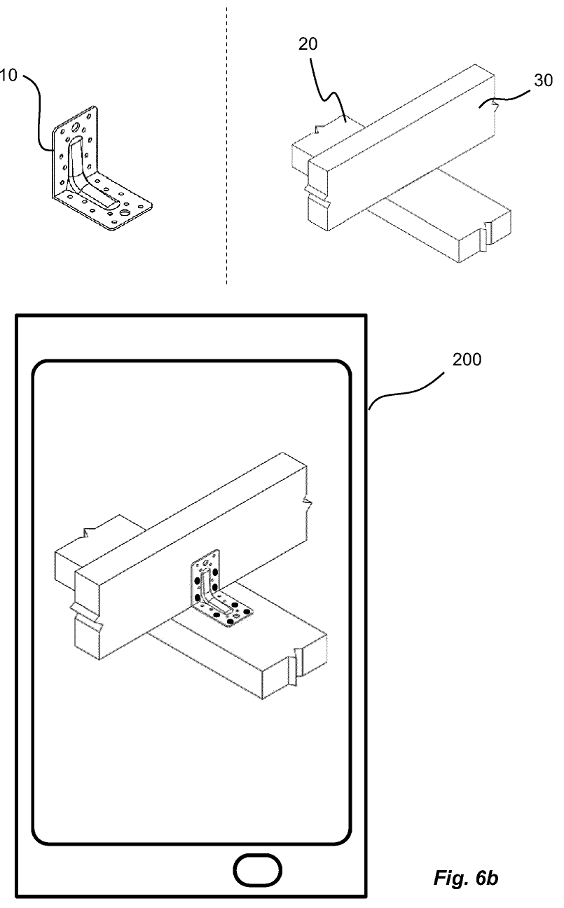

Now turning to FIG. 6a, an example of a mobile application 340 is shown. The view shown in FIG. 6a represents an initial view of the mobile application 340 presented by the GUI 205 of the mobile terminal 200. The mobile application 340 is configured to execute at least one of the methods 400, 420 previously explained.

Upon start of the mobile application 340 the user 1 is shown three different input sections 205a-c. The first input section 205a is a camera view, allowing a user to scan an existing bracket 10 and/or support member configuration 20, 30.

The second input section 205b allows a user 1 to manually type an article number for a bracket 10 to be used.

The third input section 205c allows the user 1 to browse through a list of available brackets 10. If a user selects the third input section 205c, first a list of bracket types is displayed. The bracket types are shown as a list of bracket connection categories, such as “wood on wood” or “wood on concrete”. The category “wood on wood” thus includes all brackets 10 intended to connect a wooden member 20 to another wooden member 30, while the category “wood on concrete” includes all brackets 10 intended to connect a wooden member 20 to a concrete member 30.

If a user 1 selects a specific connection category, further sub-categories are listed for selection by the user 1. For example, if a user 1 selects the category “wood on wood” the user 1 if directly prompted to select any of the sub-categories “beam on beam”, “beam on pillar”, “exchange”, or “pillar on beam”. On the other hand, if the user 1 selects the category “wood on concrete”; the user 1 is directly prompted to select any of the sub-categories “beam on concrete”, “pillar on concrete”, or “beam on concrete wall”.

After selecting a desired sub-category, corresponding to the intended bracket connection 40 to be formed, the mobile application 340 displays a list of suitable brackets 10. Typically, this list comprises available brackets 10 of a single type, but in different dimensions depending on the dimensions of the support members 20, 30. Each available bracket 10 has a unique identifier, such as an article number.

In FIG. 6b another example of how the mobile application 340 is executing some parts/steps of the methods 400, 420 is schematically shown. First, the user 1 is using the camera of the mobile terminal 200 to film an existing situation; this may either be an existing bracket 1, as shown in the upper left of FIG. 6b, or an existing configuration of support members 20, 30, as shown in the upper right of FIG. 6b.

By analysing the captured photo/image stream, preferably by means of real-time image processing, the method performs a step of visualizing the existing configuration, i.e. the bracket 10 or the support member 20, 30, in augmented reality. Hence, if the user 1 is filming a bracket 10, the mobile terminal 200 will display the bracket 10, as well as the support members 20, 30 arranged in their intended position relative the bracket 10.

On the other hand, if the user 1 is filming the support members 20, 30, the mobile terminal 200 will display these support members 20, 30, as well as the bracket 10 arranged in its intended position relative the support members 20, 30.

Preferably, the bracket connection 40 is not only shown in terms of bracket type and support member types. Rather, the user 1 is also shown the fastening configuration, i.e. which fastening holes 14, 18 should be used for proper attachment of the bracket 10 to the support members 20, 30, and for ensuring that the bracket connection 40 will cope with the required load capabilities.

This is preferably done by highlighting the fastening holes 14, 18 to be used to the user 1 through the GUI 205, in an augmented reality view, as is shown in FIG. 6b. In the view shown to the user 1, only one of the bracket 10 or the support members 20, 30 is a recorded existing structure, while the other of the bracket 10 and the support members 20, 30, as well as the nails/screwed for indicating the correct fastening configuration of the bracket connection 40, are calculated and displayed to the user 1 using augmented reality. In FIG. 6b, the correct fastening configuration is shown by four highlighted fastening holes on each bracket part 12, 16, thereby clearly indicating how to use the bracket 10 correctly for the current support members 20, 30.

By providing a complex pattern of fastening holes 14, 28 on the bracket 10 the versatility of the bracket 10 is greatly improved as different use of the fastening holes 14, 18 will allow the bracket 10 to be properly used for several different support members 20, 30. In combination with the methods 400, 420, allowing a user 1 to immediately realize the correct use of the bracket 10 for the support members 20, 30, improved handling of the bracket 10 is ensured which so far has not been available, nor suggested.

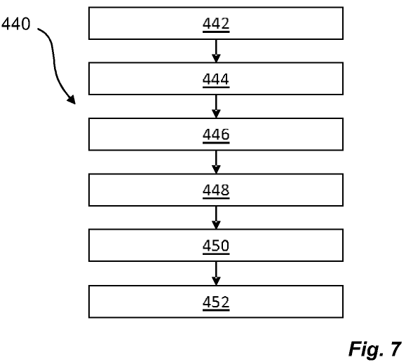

In FIG. 7 another computer-implemented method 440 is shown, performed for inspecting and/or evaluating an existing bracket connection 40. This method 440 is preferably performed when someone is interested in a specific building construction site, either for checking that the bracket connections 40 are properly installed, or for evaluating the load capabilities of the building structures. Method 440 may be performed in combination with methods 400, 420 previously described.

As for the previous methods 400, 420, the method 440 is preferably performed by a user 1 accessing a dedicated mobile application 340-346 on a mobile terminal 200, whereby the user 1 is allowed to provide user input to the mobile application 200, and hence to the method 440, through the GUI 205.

An initial step 442 is performed by the user accessing the mobile application 340-346, and filming an existing bracket connection 40. From the captured image data of the bracket connection 40 the method proceeds by performing a step 444 of determining the bracket 10 properties, as well as properties of the support members 20, 30 of the existing bracket connection 40.

Optionally, the method 440 performs an additional step 446 of determining additional properties of the bracket connection 40, not necessarily being linked to the particular bracket connection 40 but rather to building site properties.

Bracket properties, determined by performing step 444, may e.g. comprise the exact type of bracket 10 (preferably identifying the exact ID or article number of the used bracket 10), or a plurality of bracket properties such as dimensions, thickness, as well as other structural features which together allows the method 440 to actually determine the exact bracket ID/article number.

Support member properties 20, 30 may comprise dimensions of the support members 20, 30, but also other material properties such as support member material, the orientation of the wood fibres (in case of wooden material), the type of wood, moisture content, and/or the density of that specific type of wood (e.g. the density of pine may vary widely), etc. These support member properties are preferably determined by image processing of the recorded image data.

Yet further, in step 444 further bracket connection properties are determined, such as the type of nails/screws used, and the number and position of the actual nails/screws used.

Additional bracket connection properties, determined by performing step 446, may e.g. comprise GPS coordinates (accessible from the mobile terminal executing the method 440), which can be used to determine e.g. saline content in the air from accessible look-up tables, or other properties that may affect the load capability of the bracket connection 40.

In a following step 448, the method 440 determines the maximum load capability of the bracket connection 40. This may be performed by determining a theoretically maximum load capability of the bracket 10, when used in an optimum configuration, and applying reduction factors based on the determined properties of the bracket itself, the support members, and other relevant properties. In other embodiments, the theoretically maximum load capability is determined based on the current fastening hole configuration of the bracket connection, and reduction factors are applied for the remaining properties being determined.

Hence, for a specific bracket there may be several maximum load capabilities stored, each load capability corresponding to a particular fastening hole configuration.

In a subsequent step 450 the method compares the determined load capability of the bracket connection with a desired load capability, which may correspond to the maximum load capability of the bracket connection.

In a final step 452 the method presents a result from the comparison to the user 1, thereby indicating if there is an issue with the bracket connection or not.

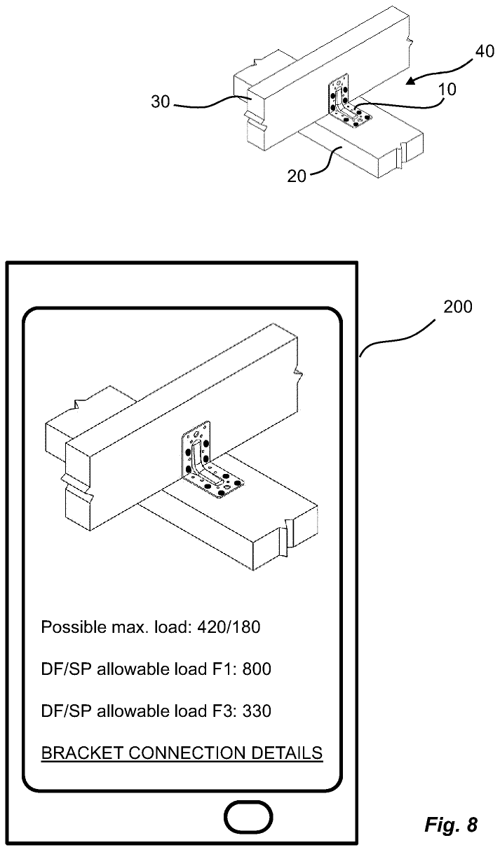

In FIG. 8 an example of the performance of the method 440 is shown. Here, a view is shown where a user 1 has recorded an image/film of an existing bracket connection 40. By analysing the captured image data, the method 440 presents the bracket connection 40 to the user 1, either as a direct visualization on the display of the existing bracket connection, or as a fetched image illustrating a similar bracket connection 40 more schematically.

Moreover, the user 1 is presented with information, as also is shown in FIG. 8. Such information may e.g. be the maximum possible load of the existing bracket connection 40, calculated from the identified bracket type, the identified support members 20, 30, as well as the identified bracket connection properties (including the fastening hole configuration, type of screws/nails/bolts) and optionally also the building site properties (e.g. gathered by analysing the GPS coordinates of the bracket connection 40, and relevant properties for that particular position such as saline content in the air, temperature, humidity, etc.).

In the shown example, the F1/F3 loads are shown as 420/180. The user 1 is also presented with information relating to the maximum allowable load for that particular bracket connection 40, when mounted in the correct and optimum manner. In the shown example, the maximum allowable load is given as 800/300, i.e. the maximum F1/F3 loads.

Optionally, the method allows a user 1 to view bracket connection details, the link indicated by the underlined “BRACKET CONNECTION DETAILS” in FIG. 8. By following that link, the user 1 access a list/information regarding the identified bracket connection properties.

The method 440 thereby allows a user to input an existing bracket connection 40 by recording an image or image stream containing that bracket information, and the method 440 provides the user 1 with immediate information regarding the actual properties of that particular bracket connection.

The inventors have realized that by providing an indication of the maximum possible load, a measure is given relating to if the bracket connection 40 is safe, or if some reinforcement action is needed.

Hence, the load capability of a given bracket connection 40 is given as a function of a number of parameters. In its most simple form, the load capability is a function of bracket type, supporting member type, and supported member type. This load capability, in its most simple form, would correspond to manufacture specifications of that particular bracket connection. However, in many cases the bracket 10 is mounted to the support members 20, 30 in a manner which is far from ideal. For example, the wrong type of fasteners is used, and/or used in a faulty pattern using the fastening holes of the bracket.

The load capability is therefore preferably calculated as a function not only depending on the bracket type and support member types, but also on the type of fastener used and in which fastening configuration. By adding fastener type and fastening configuration to the equation, a reduction factor of the maximum load capability is provided which his calculated and provided to the user 1. The identification of the type of fastener may be obtained using OCR, QR-code reader, reflexion from the specific type of coating or coating otherwise providing an identification. In particular, in situations where nails are used as fasteners, the length is impossible determine afterwards without damage to the wood or connection in general due to the rough surface of the nails e.g. an annular ring shank.

Even further, the method may identify additional bracket connection properties as explained above, which either alone or in combination provide an additional reduction factor for the possible maximum load capability of the bracket connection.

Other benefits are also obtained by performing the above described methods 400, 420, 440. One particular advantage relates to traceability of existing bracket connection 40. For example, when an inspector or auditor is auditing a building construction site the traceability of each product used (i.e. bracket connection 40) may be performed. If a bracket 10 is equipped with a barcode or stamp or other identification the origin of the material, batch number, place of manufacturing may be retrieved by the method fetching bracket information. In this way it is e.g. possible for a user to access such bracket information, and thereby immediately get a measure of manufacturing details, such as e.g. carbon footprint. A bracket manufacturer may thus provide traceability of their products. For example, a lower carbon footprint may be assigned to an existing bracket 10 if it is determined that the construction site for the particular bracket is in Europe, and that the bracket has in fact been manufactured in Europe. Should the bracket 10 have been manufactured in e.g. China, a higher carbon footprint would need to be assigned.

The above description provides improved methods for deciding on bracket connections 40, as well as methods for inspecting and evaluating existing bracket connections 40. Preferably, the methods are performed on a mobile terminal allowing augmented reality to enhance the user experience, and to provide additional information for the user 1 in order to provide for decision making and inspection and evaluation of bracket connections. Hardware components for augmented reality would typically comprise a processor, display, sensors and input devices, already present in modern mobile terminals 200, as well as a camera and optionally microelectromechanical systems (MEMS) sensors such as an accelerometer, and GPS.

Further to the hardware components, the methods 400, 420, 440, when executed by a mobile terminal 200, require some software dedicated to image processing and augmented reality. Such software is preferably configured to derive real world coordinates, independent of camera, and camera images by image registration processing, and using different methods of computer vision, mostly related to video tracking.

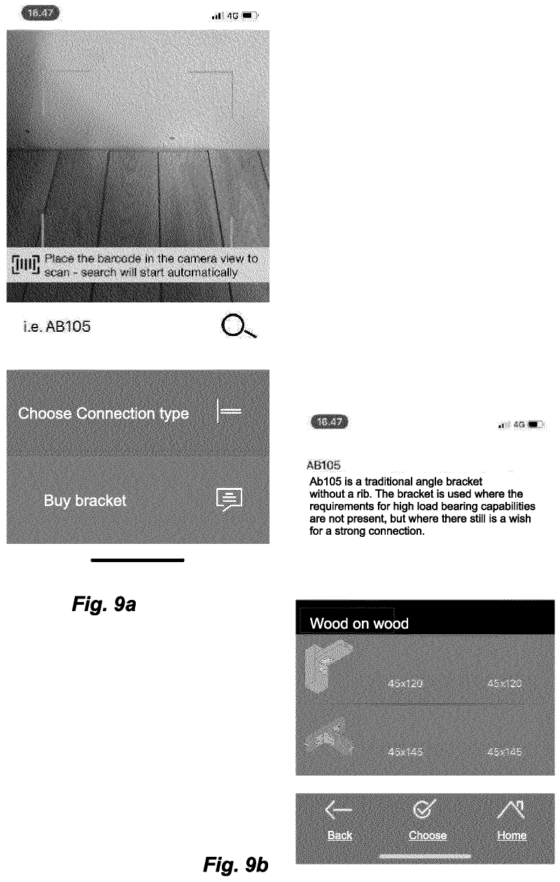

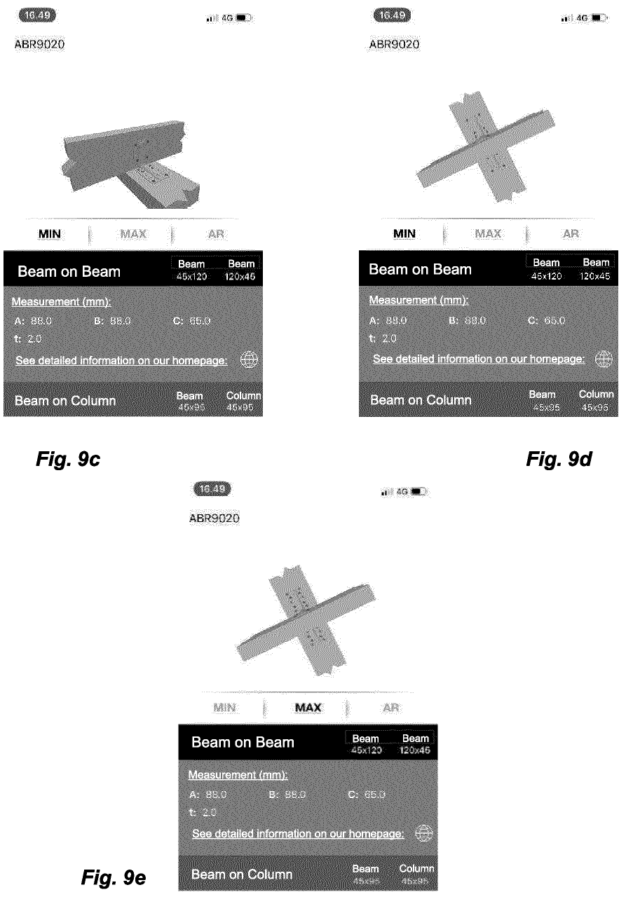

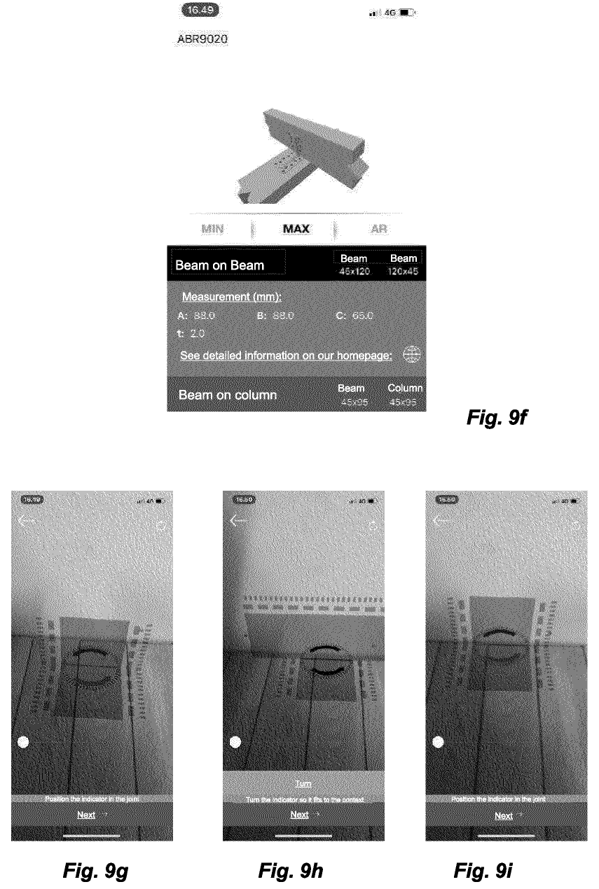

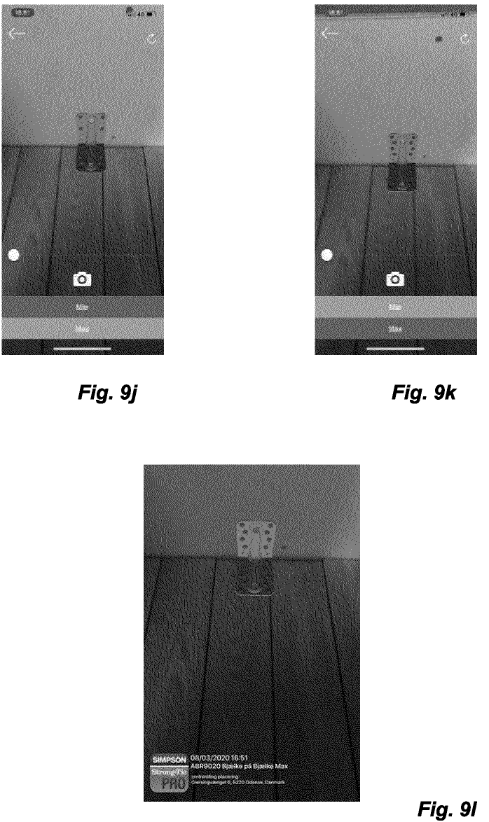

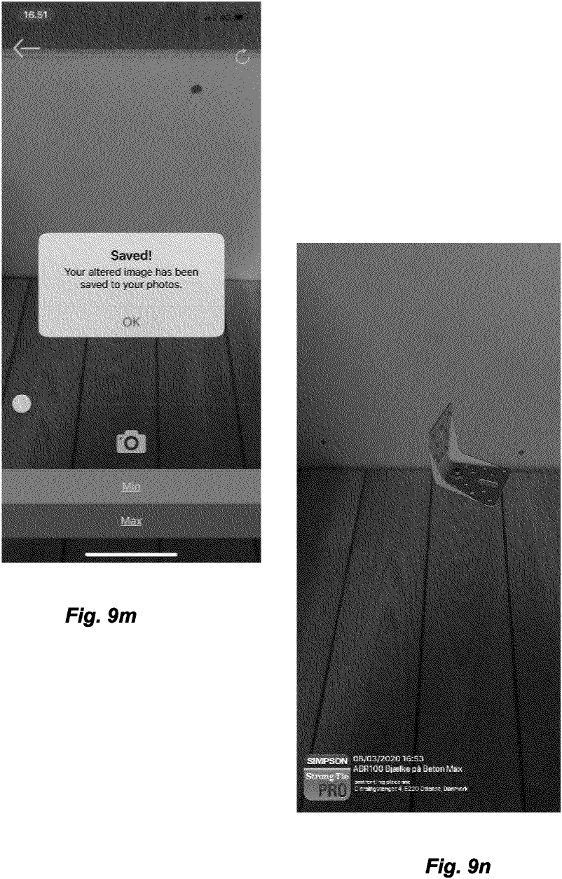

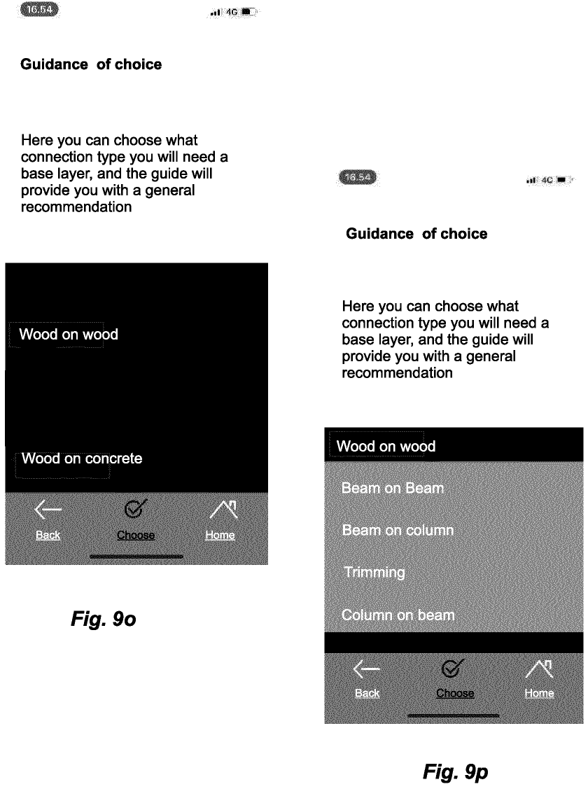

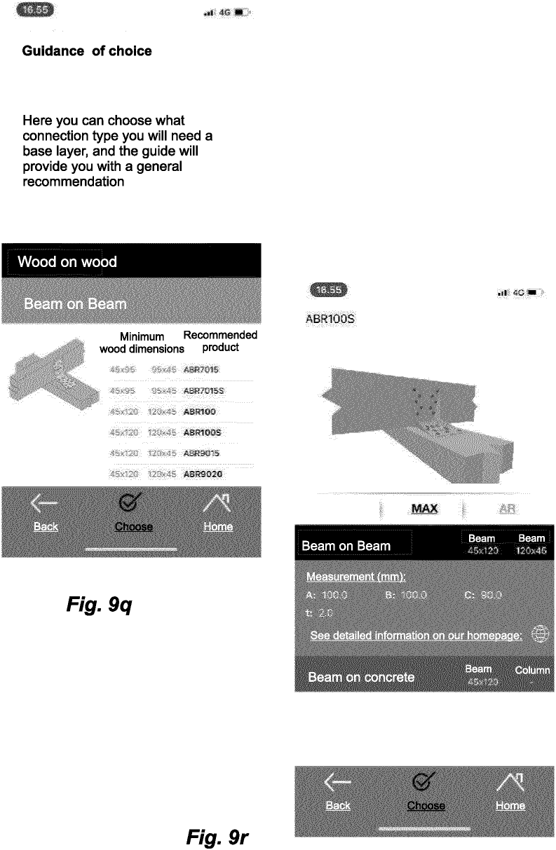

Now turning to FIGS. 9a-r, different screenshots of a mobile application executing different methods/method steps according to various embodiments are shown.

In FIG. 9a, the user 1 is allowed to film an existing environment to identify a bracket 10, or to type or browse for brackets 10. In FIG. 9b, a bracket 10 of type AB105 is selected, whereby the method displays details of the bracket 10 and its intended use (i.e. how it should be used with support members 20, 30).

FIG. 9b shows another view, where a user 1 has requested details for bracket type ABR9020. The view displays the particular fastening hole configuration for a minimum load capability. As can be seen in FIG. 9d, the view of the bracket 10 and its associated support member is 3D supported, making it possible to rotate the view for better understanding.

In FIG. 9e, the user 1 has select to view the fastening hole configuration for maximum load capability of the bracket connection. In FIG. 9f, the view of the bracket connections has been rotated.

FIGS. 9g-i show screenshots of the augmented reality support. The method identifies a support structure, such as the corner shown in FIG. 9g, and determines the bracket position from the image data. Once the user 1 accepts the position of the bracket 10, the method further provides an augmented view as shown in FIGS. 9j-l. FIG. 9j shows the selected bracket in its minimum load configuration, while FIG. 9k shows the selected bracket in its maximum load configuration. In FIG. 9l, a photo has been taken and stored on the mobile terminal. FIG. 9m shows a confirmation that the photo has been stored.

FIG. 9n shows another stored image of an augmented reality view of a computer generated bracket in a real-world environment.

FIGS. 9o-q show screenshots of how brackets are browsed in the mobile application, and FIG. 9r shows a screenshot when a particular bracket has been selected. Upon such selection, further details of the bracket are presented to the user, and also a 3D model in the upper field of the GUI.

The invention has been described above in detail with reference to embodiments thereof. However, as is readily understood by those skilled in the art, other embodiments are equally possible within the scope of the present invention, as defined by the appended claims.

1. A computer-implemented method, implemented on a mobile terminal for deciding on a bracket connection, comprising:
selecting one of a specific bracket type or a specific configuration of a supported member and a supporting member,
identifying, based on the selected bracket type if such is selected, at least one configuration of a supported member and a supporting member associated with the selected bracket type, or, based on the selected specific configuration of a supported member and a supporting member if such is selected, at least one bracket type being associated with the configuration of the supported member and the supporting member,
the bracket and the configuration of the supported member and the supporting member together forming a bracket connection, and
determining one or more properties of the identified bracket connection.

2. The method of any of the preceding claims, wherein the step of selecting a specific bracket type is performed by a user scanning a bracket bar code.

3. The method of claim 1, wherein the step of selecting a specific bracket type is performed by a user inputting a specific bracket ID, such as a bracket article number.

4. The method of claim 1, wherein the step of selecting a specific bracket type is performed by a user recording image data of an existing bracket, and determining the specific bracket type from said image data.

5. The method of claim 1, wherein the step of selecting a specific configuration of the supported member and the supporting member is performed by a user recording image data of an existing configuration, and determining the specific configuration from said image data.

6. The method of any of the preceding claims, further comprising presenting said bracket connection properties to a user.

7. The method of any of the preceding claims, wherein the bracket connection properties comprise a maximum load capability of the bracket connection.

8. The method of any of the preceding claims, wherein the bracket connection properties comprise a fastening configuration.

9. The method of any of the preceding claims, further comprising presenting the determined bracket connection to a user.

10. The method of claim 9, wherein presenting the determined bracket connection is performed using augmented reality, adding a graphical model of the identified bracket type to the image of the support members configuration, or adding a graphical model of the support members configuration to the image of the bracket type.

11. The method of any of the preceding claims, further comprising inspecting and evaluating a bracket connection by:
recording an image of an existing bracket connection,
determining the bracket type and support member configuration from said recorded image, the bracket type and support member configuration together forming a determined bracket connection, and
determining a possible load capability of the determined bracket connection based on the existing and determined bracket connection.

12. A computer-implemented method, implemented on a mobile terminal or device for inspecting and evaluating a bracket connection, comprising:
recording an image of an existing bracket connection,
determining the bracket type and support member configuration from said recorded image, the bracket type and support member configuration together forming a determined bracket connection, and
determining a possible load capability of the determined bracket connection based on the determined bracket connection.

13. The method of claim 12, further comprising presenting information regarding the determined load capability to a user.

14. The method of claim 13, further comprising comparing the determined possible load capability with a maximum load capability of the bracket connection, and presenting information relating to said comparison to the user.

15. The method of any of claims 12-14, wherein the step of determining the possible load capability of the bracket connection is further based on additional bracket connection properties.

16. The method of claim 15, wherein additional bracket connection properties comprises the used fastening hole configuration, the type of fasteners used, type of material of the supported member and/or the supporting member, such as orientation of wood fibres in case any of the supporting or supported members are made of wood, type of wood/concrete in case any of the supporting or supported members are made of concrete, actual density of the particular material, moisture content of the supporting or supported members, and/or age of the bracket.

17. The method of any of claims 12-16, wherein the step of determining the possible load capability of the bracket connection is further based on additional building site properties, such as location and/or air composition.

18. A data processing apparatus, such as a mobile terminal or device, comprising a processor adapted to perform the method according to any of the preceding claims.

19. A computer program comprising instructions which, when the program is executed by a computer or processor, cause the computer to carry out the method according to any of claims 1-17.

20. A computer-readable medium comprising instructions which, when executed by a computer or processor, cause the computer to carry out the method according to any of claims 1-17.
